(19) United States
(12) Patent Application Publication
(10) Pub. No.: US 2013/0271969 A1
(43) Pub. Date: Oct. 17, 2013

(54) APPARATUS FOR PROVIDING LIGHTING TO A WATER FOUNTAIN WITH NO EXTERNAL POWER SOURCE

(71) Applicants: Douglas A. Ruthenberg, Weeki Wachee, FL (US); William H. Corbin, Spring Hill, FL (US)

(72) Inventors: Douglas A. Ruthenberg, Weeki Wachee, FL (US); William H. Corbin, Spring Hill, FL (US)

(21) Appl. No.: 13/448,139

(22) Filed: Apr. 16, 2012

(51) Int. Cl. F21L 13/00

(52) U.S. Cl. 362/192

(57) ABSTRACT

An apparatus for providing instant lighting to a fountain nozzle without using an external power source, where the apparatus includes a generator that generates an AC voltage from the rotation of an impeller being impacted by the flow of water through the fountain water supply source. The generated voltage is rectified and powers an array of LED bulbs where the bulbs are lighted in sequence by way of a controller circuit.

### FIELD OF THE INVENTION

The invention relates to the use of light emitting diode (LED) technology to provide multicolor effects in fountains, pools and spas, without an external power source.

### BACKGROUND OF THE INVENTION

LED technology for water use is common in the art. However, the object of the present invention, contrary to the prior art, is to provide the ability to have a multicolor effect in featured water fountain display applications where the LEDs are sequenced to turn on predetermined arrays of different colored LEDs thereby providing a dynamic multicolored illumination effect without the need for using an external AC power source.

### SUMMARY OF THE INVENTION

The present invention allows for instant lighting of a fountain nozzle with no external power source. It works on new or existing installations.

The power of the water flow is harnessed by installing a power module inline in the plumbing system just before the fountain nozzle. For example, the power module is installed using a 2 inch PVC union. Once the power module installation is complete, an existing nozzle with a selected featured display pattern can be reinstalled or another nozzle with a different featured display pattern can be installed to create a desired and brilliantly lit stunning water feature.

In the power module the water is directed through a changeable orifice into the power chamber. This increases the pressure and water velocity allowing it to act with great force against a moveable curved blade impeller that turns the AC power generator. The water then enters a low pressure accumulator chamber which reduces its speed. The water is now ready to accelerate thru the fountain nozzle.

The power is carried internally to a lighting control board. The control board and the LED board are assembled and mounted back to back and encapsulated in a ring that completely encircles the fountain nozzle. The formed light ring is removable for replacement should a failure occur. The circuitry of the light ring is water proofed using a resinous potting compound.

### BRIEF DESCRIPTION OF THE DRAWINGS

In the accompanying drawings:

FIG. 1 is a conceptual partially exploded view of the present invention;

FIG. 2 is a cross-sectional view of the present invention;

FIG. 3 is a cross-sectional exploded view of the impeller and power generator portion of the present invention in relation to the impeller housing portion of the present invention;

FIG. 4 is depicts an example of an arrangement of a practical application of the arrays of LED bulbs on a circuit board wafer lighting ring;

FIG. 5a is a schematic wiring diagram of a typical application of a controller circuit, an A/C rectification circuit, an LED supply circuit and a logic supply circuit; and

FIG. 5b is a schematic wiring diagram of a typical LED circuitry of the LED bulb arrays depicted in FIG. 4.

### DETAILED DESCRIPTION OF THE INVENTION

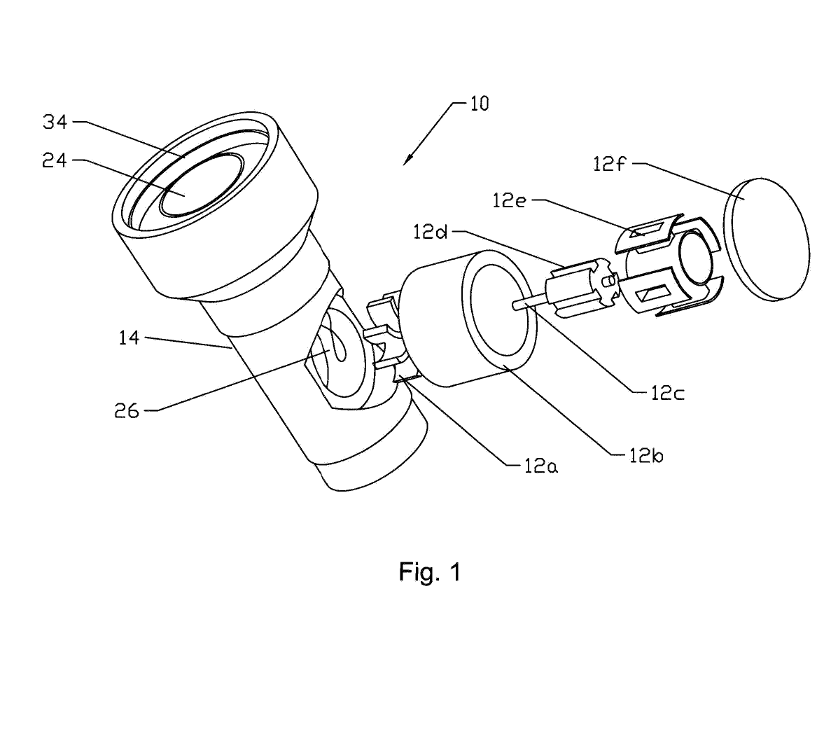

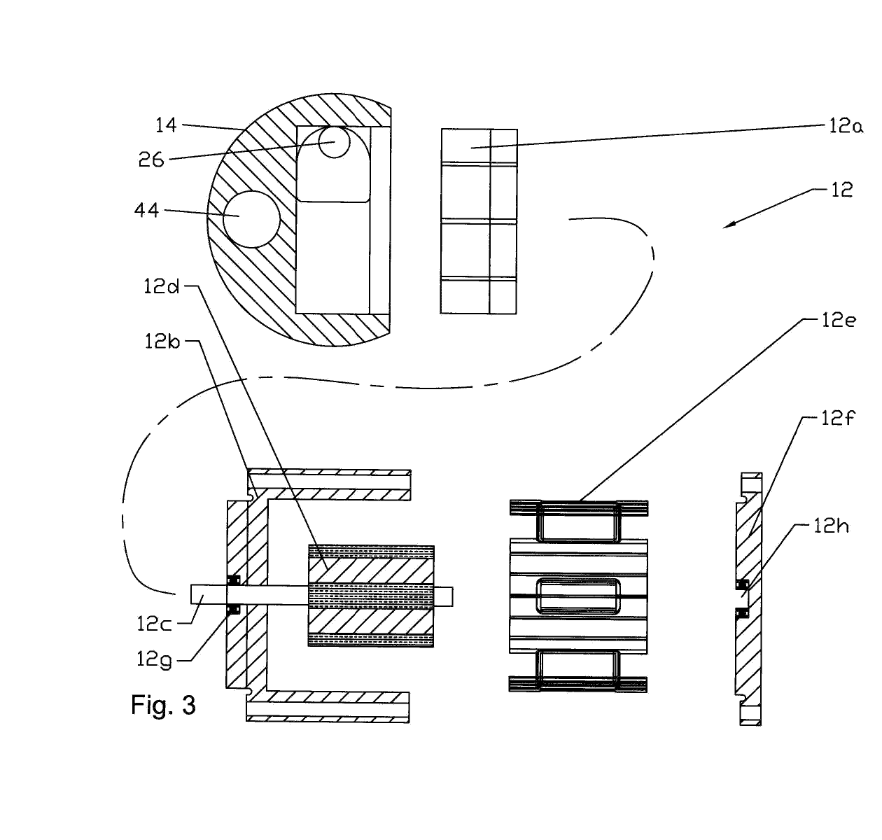

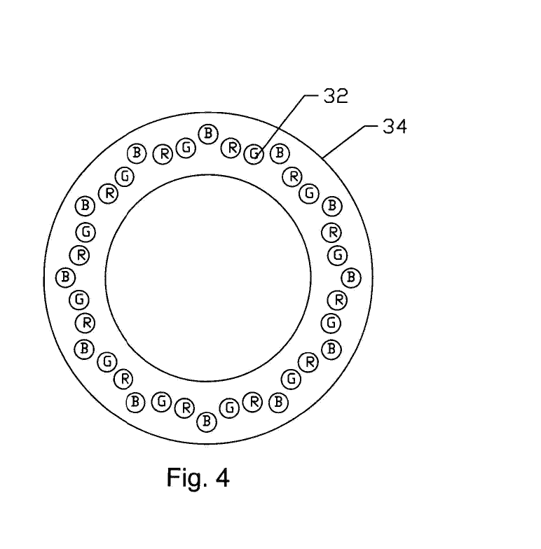

Referring now to the drawings, FIGS. 1-4, the invention is an apparatus for providing instant lighting to a fountain nozzle without using an external power source and is generally numbered 10.

The apparatus 10 includes a plurality of different colored light emitting diode (LED) bulbs 32 mounted in a predetermined spaced-apart arrangement on a circuit board wafer ring 34. A power module generator assembly 12 comprises an impeller 12a having a plurality of radially directed blades and is mounted on a shaft 12c which is in mechanical communication with a generator (armature 12d and stator 12e) mounted within a generator housing 12b. The generator (12d,12e) generates a variable AC voltage created by the rotation of the impeller 12a. The rotation is caused by a flow of water directed to a featured fountain display nozzle 24. The generator housing has an end cap 2f and the shaft rotates within front bearing 12g and rear bearing 12h.

The featured fountain display nozzle 24 is the nozzle that provides the spray pattern observed when the fountain is operating. Different spray patterns can be utilized to provide different effect and themes. The objective the present invention is to provide lighting to accompany the spray pattern without the need to provide power from an external power source. Nozzle 24 is typically assembled to the impeller housing upper end using a threaded socket connection 46.

An impeller housing 14 is included and comprises at an intermediate location thereof an impeller chamber 16 formed by a recessed portion located within the impeller housing 14. The impeller chamber 16 is configured to receive the impeller 12a and allow for the rotation of the impeller 12a within the chamber 16. An accumulator chamber 18 is spaced-apart from the impeller chamber 16 and located downstream of the flow of water exiting an impeller exit 20. A water flow outlet 22 from the accumulator chamber 18 is configured to receive and mechanically engage the featured fountain display nozzle 24.

An impeller inlet nozzle 26 is configured to allow the flow of water to enter the impeller chamber 16 and to impact the blades of the impeller 12a causing the blades to rotate. An orifice member 28 is configured to be inserted within the impeller inlet nozzle 26. The impeller inlet nozzle 26 has means for selectively interchanging the orifice member 28 for using a desired orifice size.

The impeller housing 14 further comprises a light shroud portion 30 extending around a portion of the featured display nozzle 24. Shroud 30 has a diameter sufficient to house the LED bulbs 32 mounted on the wafer ring 34. The impeller housing 14 further comprises means for mechanically installing and uninstalling the impeller housing 14 to or from a water supply source 42. Although there are several ways known in the art on how to provide a coupling that can be quickly and easily disassembled, one simple and preferred method is to use a union coupling fitting 40.

The impeller inlet nozzle 26 is preferably internally threaded for threadedly engaging a threaded orifice member 28. The threaded engagement serves as the means for selectively interchanging the orifice member 28 for using the desired orifice size. For example and by no means limited thereto, an orifice can be made from a variety of materials, and one suggestion would be to make the orifice using a ½ inch nylon Allen head flat point set screw, and sizing the orifice from ⅜ inch diameter to 1/16 inch diameter.

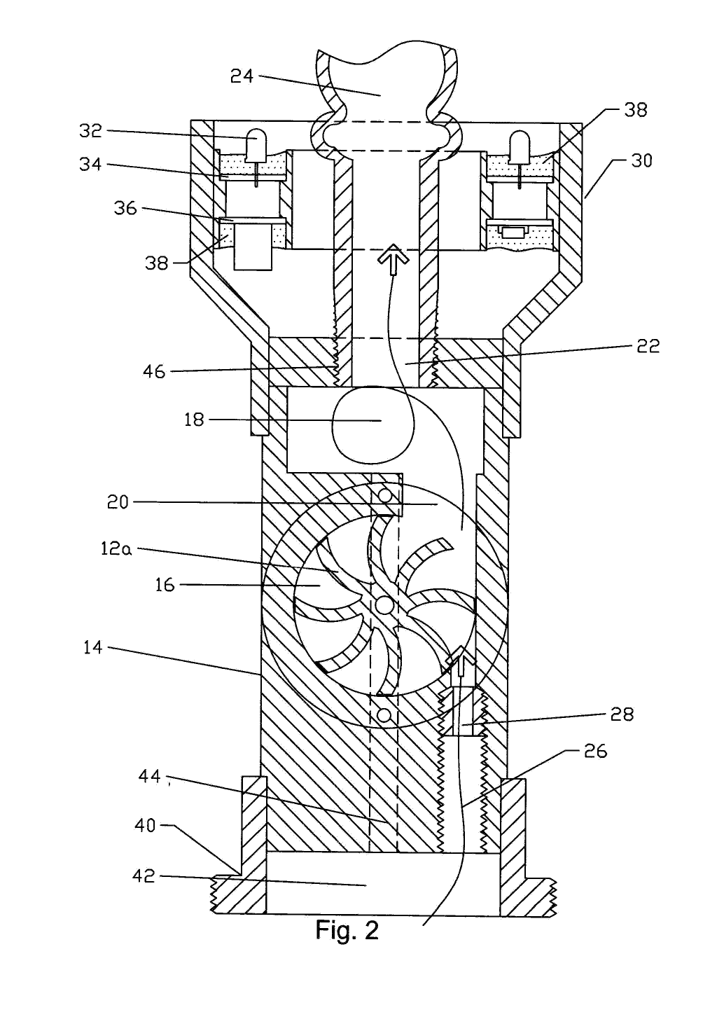

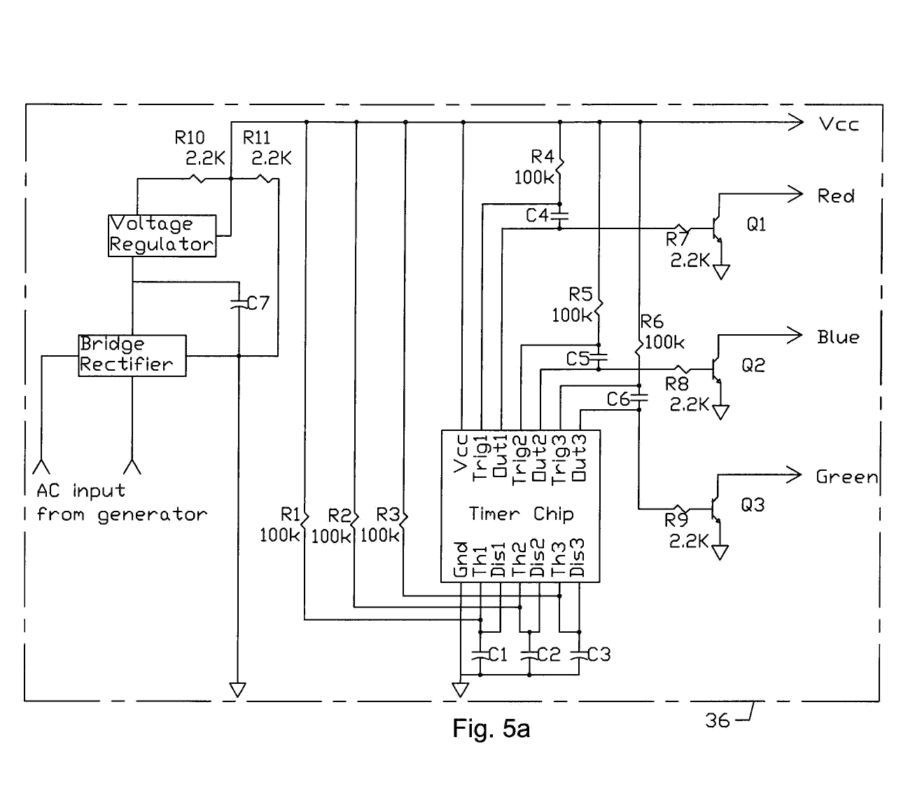

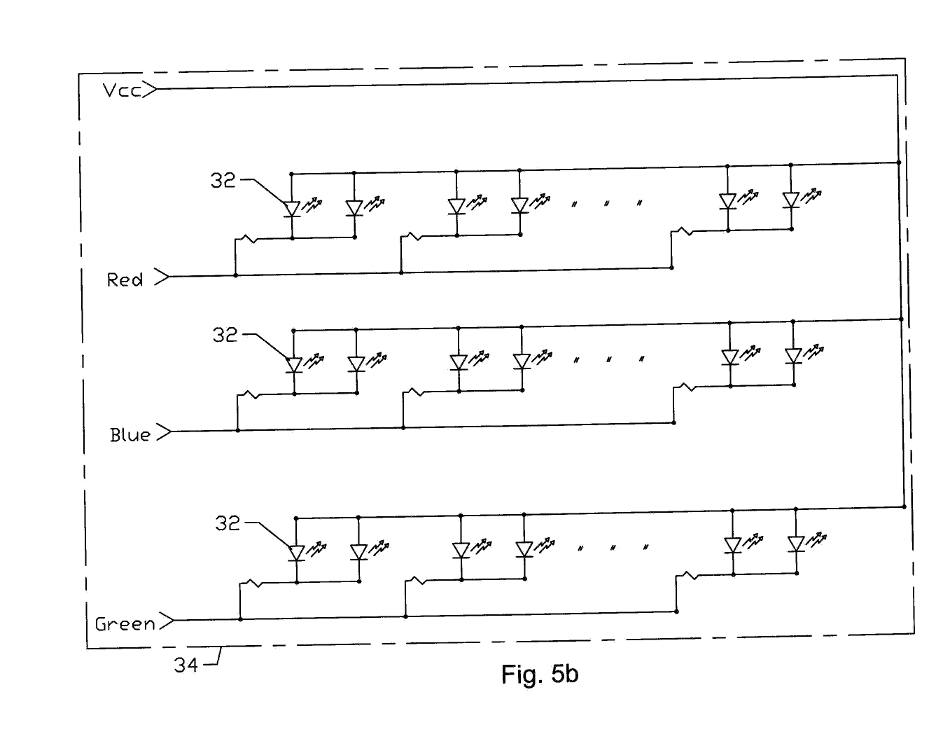

As depicted in FIGS. 5a-5b, an LED light driver board 36 is in electrical communication with the LED bulbs 32 and in electrical communication with the generator (12d,12e). The LED light driver board 36 comprises a circuit for rectifying and regulating the generated AC voltage from the generator to a DC voltage. A preferred feature of the present invention is the providing of a controller circuit that controls a timed lighting sequence of the LED bulbs 32. This allows the sequencing of lights progressing or transitioning from red to blue to green colors at a desired time interval that is pre-programmed in the micro-processing chip. Although the plurality of different colored light emitting diode (LED) bulbs 32 can include several combination of desired colors, the most common ones used in the intended application is preferably a combination of red, blue and green LED bulbs. As shown in FIG. 2, the LED bulbs 32 as well as the LED driver board 36 are sealed using a resinous potting compound 38.

In another embodiment of the invention 10, the impeller housing 14 further comprises a water flow bypass chamber 44 that extends from a lower end of the impeller housing 14 and extends upwardly behind and separated from the impeller chamber 16 and exits into the accumulator chamber 18.

To describe a rather general operating summary, once the generator is up to speed, it produces an AC electrical signal that is transmitted to the driver board via internal wiring. Referring to FIGS. 5a-5b, which represents one example of a typical circuit for operating the present invention, the driver board first produces a DC voltage via the bridge rectifier and capacitor C7. The DC voltage is further regulated by the voltage regulator and R10 and R11 to a constant 6 volts. The positive regulated voltage is presented on the Vcc bus to the rest of the circuitry. The timer chip, which serves as a micro-processor, with the help of the capacitors C1, C2, C3 will provide an approximately 30 second timed event and is configured in such a way that when the output is transitioning to a low state it starts the second timer and it runs for the approximate 30 seconds. This process continues through the third timer in the timer ship and when it is complete it starts the first timer and the cycle starts all over again. Each output of the timer chip is connected to a power transistor and the transistor drives the LEDs 32 located on the LED board 34. There are three colors of LEDs and preferably, there are 12 LEDs of each color. The colors of LEDs are red, blue, green and are configured in a series parallel configuration. This configuration allows the use of much smaller resisters for better heat dissipation.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. An apparatus for providing instant lighting to a fountain nozzle without using an external power source comprising:
a plurality of different colored light emitting diode (LED) bulbs mounted in a predetermined spaced-apart arrangement on a circuit board wafer ring;
a power module generator assembly comprising an impeller having a plurality of radially directed blades and being mounted on a shaft which is in mechanical communication with a generator mounted within a generator housing, the generator generating a variable AC voltage created by the rotation of the impeller, said rotation being caused by a flow of water directed to a featured fountain display nozzle;
an impeller housing comprising at an intermediate location thereof an impeller chamber formed by a recessed portion located within the impeller housing, the impeller chamber being configured to receive the impeller and allow for the rotation of the impeller within the chamber, an accumulator chamber spaced-apart from the impeller chamber and located downstream of the flow of water exiting an impeller exit, a water flow outlet from the accumulator chamber wherein the outlet is configured to receive and mechanically engage the featured fountain display nozzle, an impeller inlet nozzle configured to allow the flow of water to enter the impeller chamber and to impact the blades of the impeller causing the blades to rotate and an orifice member configured to be inserted within the impeller inlet nozzle, the impeller inlet nozzle having means for selectively interchanging the orifice member for using a desired orifice size, the impeller housing further comprising a light shroud portion extending around a portion of the featured display nozzle and having a diameter sufficient to house the LED bulbs mounted on the wafer ring, and means for mechanically installing and uninstalling the impeller housing to or from a water supply source; and
an LED light driver board in electrical communication with the LED bulbs and in electrical communication with the generator, wherein the LED light driver board comprises a circuit for rectifying and regulating the generated AC voltage from the generator to a DC voltage.

2. The apparatus according to claim 1, further comprising:
a controller circuit for controlling a timed lighting sequence of the LED bulbs.

3. The apparatus according to claim 1, wherein the impeller housing further comprises a water flow bypass chamber extending from a lower end of the impeller housing and extending upwardly behind the impeller chamber and exiting into the accumulator chamber.

4. The apparatus according to claim 1, wherein the plurality of different colored light emitting diode (LED) bulbs include a combination of red, blue and green LED bulbs.

5. The apparatus according to claim 1, wherein the means for mechanically installing and uninstalling the impeller housing to or from the water supply source is a union coupling fitting.

6. The apparatus according to claim 1, wherein the impeller inlet nozzle is internally threaded for threadedly engaging a threaded orifice member, the threaded engagement serving as the means for selectively interchanging the orifice member for using the desired orifice size.
